(19) United States
(12) Patent Application Publication
(10) Pub. No.: US 2015/0172154 A1
(43) Pub. Date: Jun. 18, 2015

(54) MINIMIZING SYMMETRICAL LATENCY IMPACT BY JITTER BUFFER FOR TDM CES

(71) Applicant: Alcatel-Lucent Canada Inc., Kanata (CA)

(72) Inventors: Kin Yee WONG, Ottawa (CA); Chad V. Mccarthy, Ottawa (CA)

(73) Assignee: Alcatel-Lucent Canada Inc., Kanata (CA)

(21) Appl. No.: 14/132,664

(22) Filed: Dec. 18, 2013

(51) Int. Cl. H04L 12/26

(52) U.S. Cl. CPC H04L 43/0829; H04L 43/0847

(57) ABSTRACT

A method and system are provided for allowing time-alignment of teleprotection measurements of power signals. Teleprotection observations are communicated between teleprotection ends through a packet switched network. At each end of a teleprotection segment, a teleprotection device communicates with the network through a router providing CES and located at the edge of the network. Playout of the jitter buffers of the CES routers is initiated only if the PDV is acceptable such that confidence that the packets from each CES router to the associated teleprotection device are synchronized. The fill level of the jitter buffer is determined a number of times, and then the average of the determined fill levels is compared with an expected fill level. If the difference between the average of the determined fill levels and the expected fill level exceeds a threshold, then the TDM CES is restarted. This is repeated until the difference is acceptable, indicating that playout of each jitter buffer is initiated at the same time.

### FIELD OF INVENTION

This invention relates to teleprotection in power grids, and more particularly to symmetric communication of teleprotection signals.

### BACKGROUND

Teleprotection is an essential requirement for operating and maintaining a reliable, robust, and safe electrical power grid. The voltage of a power signal is measured at a first location and transmitted over a communication channel to a second location. Simultaneously, the voltage of the power signal is measured at the second location and transmitted over a communication channel to the first location. Comparison of time-aligned observations of the power signal may reveal different measured values of the voltage at each location. This is usually indicative of a fault in the power grid, and action can be taken to remedy the fault.

The voltage measurements must be time-aligned. There is inevitably some delay in communicating between the two locations, but TDM networks offer a very symmetric communication channel. Delays introduced by the communication channel in one direction are generally the same as delays introduced by the communication channel in the other direction. The delays are effectively the same in each direction, so time-alignment of observations is still possible.

Nowadays core networks are evolving to packet switched networks. However legacy systems still require TDM services. Circuit Emulation Services (CES) are used to provide TDM services, as are required by legacy teleprotection systems, over packet switched networks. The routers at the edge of the packet switched network provide CES, and the devices of the teleprotection system which measure the current of the power signal send their measured observations to the routers over T1/E1 lines. The routers use their CES to transmit the measured observations to each other as packet data. The observations are then converted back into TDM format and sent to the teleprotection devices over T1/E1 lines, or other serial interfaces such as c37.94, E&M, X.21, and RS-232, where they are used in teleprotection analysis.

It is important that the packets containing the measurements are received by each teleprotection device at the same time. However packet networks are not entirely deterministic. Packet arrival time can vary as the packet traverse the packet network. For example, routers along the path typically use store-and-forward techniques. As the time for which a packet is stored by a router before it is forwarded along the path can vary, the arrival time of the packet can also vary. This is referred to as Packet Delay Variation (PDV). The routers providing CES (herein after referred to as “CES routers”) deal with this by using a jitter buffer. The router stores incoming packets in a jitter buffer and transmits them at a regular periodicity, equal to the average gap between packet arrivals, to other components of the router that convert them to TDM format.

In order for this to work, the router waits until its jitter buffer fills to a certain level before playing out the jitter buffer. In this way there may still be variation in the arrival time of the first packets, but the length of time between arrival and transmission is long enough to account for this variation. Unfortunately the routers may not always initiate play out of their jitter buffers at the same time. For example, playout may be set to begin when the jitter buffer is half full, which may be for the sake of example when three packets are in the jitter buffer. If the PDV of the packets causes three packets to arrive at one CES router in the same time as two packets arrive at the other CES router, then playout will be initiated earlier the first CES router than at the second router. Since the arrival rate of packets will on average be the same at each CES router, then a CES router which initiated playout too early because PDV in the initial packets caused the jitter to fill too early will have a steady state fill level of its jitter buffer lower than expected. Thereafter the teleprotection devices will receive packets that are one packet arrival time (on the order of milliseconds) out of sync with each other. The teleprotection devices will conclude that there is a fault in the power grid when in fact there may not be one.

A system and method which improved playout initiation time even when observations are transmitted over non-deterministic communication networks would allow teleprotection systems to better use packet switched networks.

### SUMMARY

According to one aspect, a method of providing teleprotection services over a packet switched network is provided. The packet switched network includes a first router providing Circuit Emulation Service (CES) and in TDM communication with a first teleprotection device and a second router providing CES and in TDM communication with a second teleprotection device. The first router and the second router are separated by the packet switched network. A TDM CES is established between the first teleprotection device and the second teleprotection device. At the first router packets are received into a jitter buffer. The fill level of the jitter buffer is determined at regular periods. After a configured number of such determinations, an average of the determined fill levels is determined. The average of the determined fill levels is compared with an expected fill level in order to evaluate jitter buffer latency. If the comparison indicates that jitter buffer latency is unacceptable, then the TDM CES is restarted. In one embodiment, the comparison indicates that the jitter buffer latency is unacceptable if the absolute value of the difference between the average of the determined fill levels and the expected fill level exceeds a predetermined threshold. In another embodiment, the comparison indicates that the jitter buffer latency is unacceptable if the difference between the average of the determined fill levels and the expected fill level exceeds a predetermined threshold or if the difference between the average of the determined fill levels and the expected fill level is below zero.

According to another aspect, a router providing Circuit Emulation Services (CES) to a first teleprotection device is provided. The router includes a jitter buffer and a CESoP processor. The CESoP processor is for establishing a TDM CES between the first teleprotection device and a second teleprotection device, for receiving packets received over a packet switched network and placing the packets in the jitter buffer, and for playing out the packets into a TDM bitstream to the first teleprotection device. The router also includes a teleprotection supporter. The teleprotection supporter is for determining the fill level of the jitter buffer at regular periods, for determining an average of the determined fill levels after a configured number of such determinations, for comparing the average of the determined fill levels with an expected fill level in order to evaluate a jitter buffer latency, and for instructing the CESoP processor to restart the TDM CES if the comparison indicates that the jitter buffer latency is unacceptable. In one embodiment the teleprotection supporter determines that the jitter buffer latency is unacceptable if the absolute value of the difference between the average of the determined fill levels and the expected fill level exceeds a predetermined threshold. In another embodiment the teleprotection supporter determines that the jitter buffer latency is unacceptable if the difference between the average of the determined fill levels and the expected fill level exceeds a predetermined threshold or if the difference between the average of the determined fill levels and the expected fill level is below zero.

The methods of embodiments of the invention may be stored as logical instructions on a non-transitory computer-readable storage medium in a form executable by a computer processor.

Embodiments of the invention allow teleprotection communications to occur over a packet switched network. By initiating playout only when the initial PDV is below a threshold, teleprotection devices receive observations from the CES routers at the correct time, allowing accurate teleprotection to be carried out even over a packet switched network.

### BRIEF DESCRIPTION OF THE DRAWINGS

The features and advantages of embodiments of the invention will become more apparent from the following detailed description of the preferred embodiment(s) with reference to the attached figures, wherein:

FIG. 1 is a block diagram of a portion of a teleprotection system according to one embodiment of the invention;

FIG. 2 is a block diagram of a portion of the teleprotection system of FIG. 1, showing a router in greater detail, according to one embodiment of the invention;

FIG. 3 is a block diagram of parts of either router of FIG. 1 according to one embodiment of the invention;

FIG. 4 is a flowchart of a method carried out by either router of FIG. 3 according to one embodiment of the invention; and

FIG. 5 is a block diagram of a computing environment according to one embodiment of the invention.

It is noted that in the attached figures, like features bear similar labels.

### DETAILED DESCRIPTION OF THE PREFERRED EMBODIMENTS

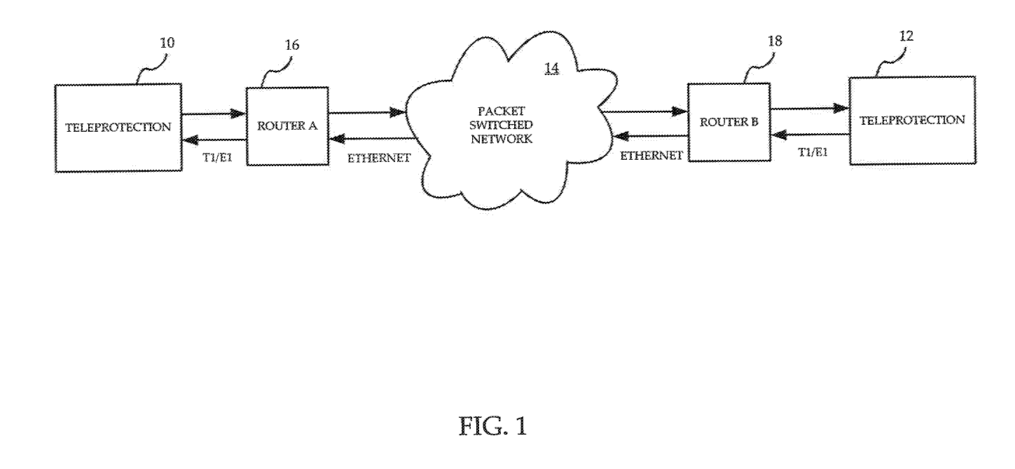

Referring to FIG. 1, a block diagram of a portion of a teleprotection system according to one embodiment of the invention is shown. A first teleprotection device 10 communicates with a second teleprotection device 12 through a packet switched network 14. Each teleprotection device 10 and 12 provides teleprotection services, including measurement of power signals. The teleprotection devices 10 and 12 exchange the measurements as packets over the packet switched network 14. The first teleprotection device 10 accesses the packet switched network through a first router 16, and the second teleprotection device 12 accesses the packet switched network 14 through a second router 18. Each router 16 and 18 provides Circuit Emulation Services, encapsulating TDM signals into packets. This allows the teleprotection devices 10 and 12 to communicate with the respective router 16 and 18 using TDM, such as through a T1 line or an E1 line, while the routers 16 and 18 communicate with each other using packets over the packet switched network 14. In this way, from the point of view of the teleprotection devices 10 and 12 the power signal measurements are transmitted in accordance with TDM, yet much of the exchange of these measurements is in packet form over the packet switched network 14.

Being a packet switched network 14, the path followed by packets from the first router 16 to the second router 18 may be different from the path followed by packets from the second router 18 to the first router 16. Even if the same path is used, the store-and-forward mechanisms used throughout the packet switched network 14 may result in different transit times in each direction.

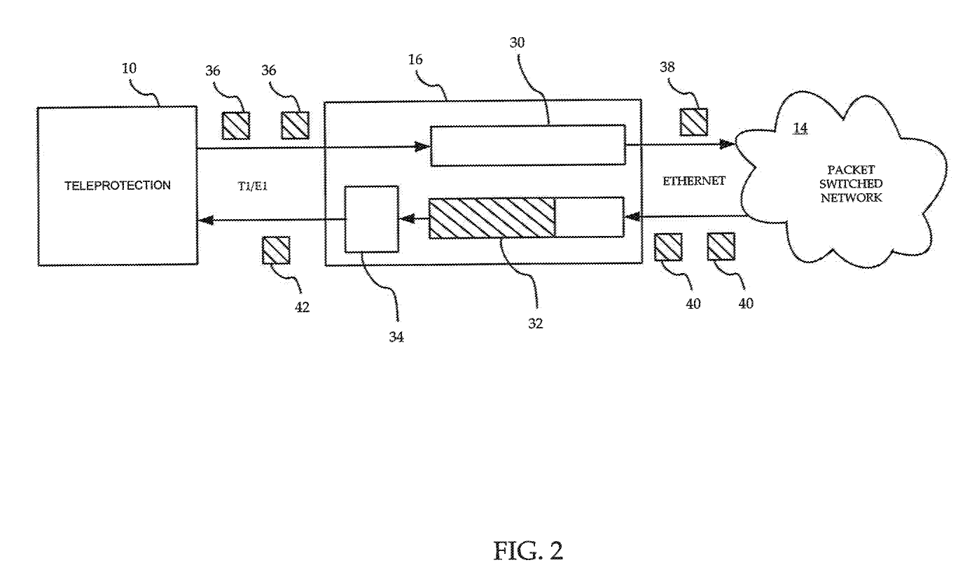

Referring to FIG. 2, a block diagram of a portion of the teleprotection system of FIG. 1, showing a router in greater detail, according to one embodiment of the invention is shown. Details of router 16 are shown, but router 18 contains similar components. The router 16 includes a packetization processor 30, a jitter queue 32, and a packet to TDM interworking function 34. Measurements 36 made by the teleprotection device 10 arrive at the router 16 in the TDM bitstream. The measurements are packetized by the packetization processor and sent as outgoing packets 38 to the rest of the packet switched network 14 (and ultimately to the router and teleprotection device at the other end of the teleprotection system). Measurements from the other teleprotection device arrive at the router 16 via the packet switched network 14 as incoming packets 40. The incoming packets 40 are placed in the jitter buffer 32, and then sent to the packet to TDM interworking function 34 where the measurements are played out in the TDM bitstream and sent to the teleprotection device 10.

When the teleprotection service is first initiated, however, the jitter buffer 32 is empty. The jitter buffer 32 accumulates the first few packets to arrive without sending them on to the TDM interworking function 34. Only when the fill level of the jitter buffer 32 reaches a playout level does the jitter buffer 32 start sending packets to the TDM interworking function 34. The start of playing out packets to TDM is referred to as initiation of playout.

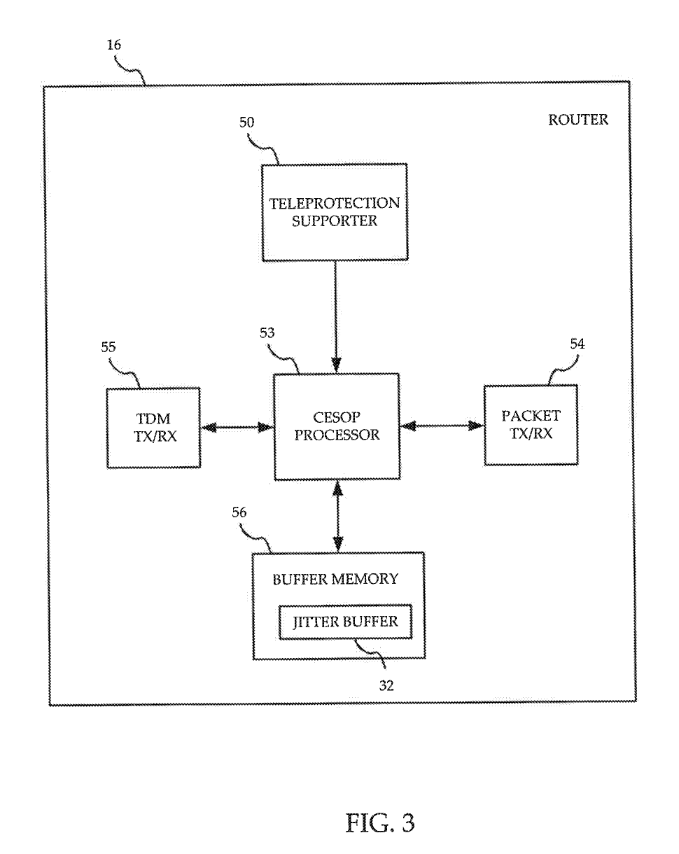

Referring to FIG. 3, a simplified block diagram of the first router 16 of FIG. 1 according to one embodiment of the invention is shown. In particular, FIG. 3 shows the components of the router 16 involved in Circuit Emulation Service over Packet (CESoP) operations. The second router 18 includes the same components shown in FIG. 3. The first router 16 includes a teleprotection supporter 50, which may more broadly be simply part of a general purpose processor. The teleprotection supporter 50 is in communication with a CESoP processor 53 which controls the CESoP functions of the router. The CESoP processor 53 is in communication with a packet transmit/receive function 54, including a packet switch and interfaces, which in turn is in communication with the rest of the packet switched network 14 (not shown in FIG. 3). The CESoP processor includes the TDM interworking function 34 and is in communication with a TDM transmit/receive function 55, which in turn is in communication with the first teleprotection device 10. The CESoP processor 53 is also in communication with a buffer memory 56. A portion of the buffer memory 56 comprises the jitter buffer 32.

Broadly, in a teleprotection system in which two routers separated by a packet switched network are each in TDM communication with a respective teleprotection device, a TDM CES is established between the first teleprotection device 10 and the second teleprotection device 12. At each router packets are received into the jitter buffer. At regular periods the fill level of the jitter buffer is determined, and after a configured number of such determinations an average of the determined fill levels is calculated. The average of the determined fill levels is compared with an expected fill level in order to evaluate jitter buffer latency. If the comparison indicates that the jitter buffer latency is unacceptable, then the TDM CES is restarted.

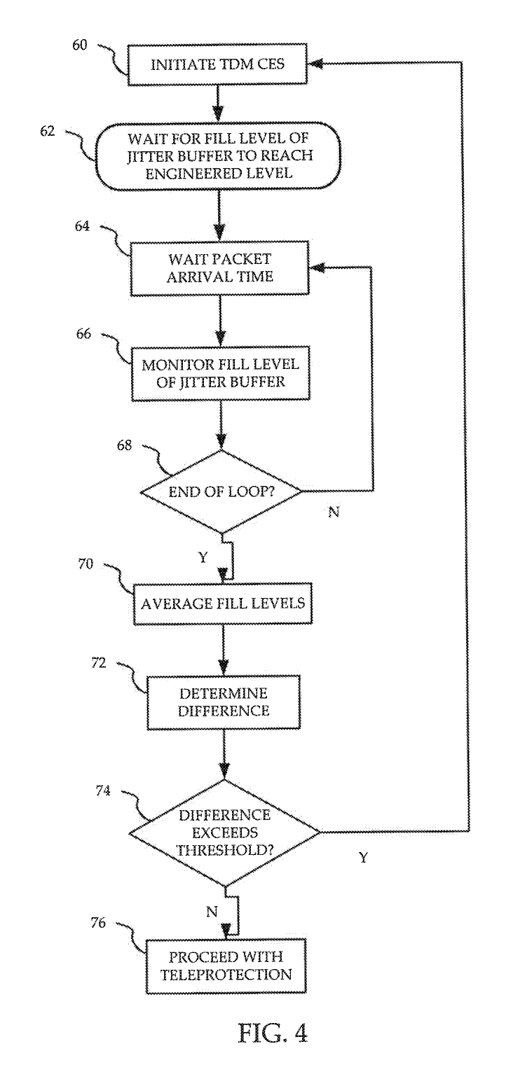

Referring to FIG. 4, a flowchart of a method carried out by the teleprotection supporter 50 of FIG. 3 according to one embodiment of the invention is shown. A similar method is carried out by the teleprotection supporter of the second router 18. At step 60 the teleprotection supporter 50 initiates a TDM CES by instructing the CESoP processor 53 to establish a TDM CES connecting the two teleprotection devices. At step 62 the jitter buffer 32 fills to an engineered level as part of the startup of the TDM CES. Once the fill level of the jitter buffer 32 reaches the engineered level playout of packets begins and the teleprotection supporter begins monitoring and averaging the fill level of the jitter buffer 32. At step 64 the teleprotection supporter 50 waits for a duration equal to the expected average time between packet arrivals. At step 66 the teleprotection supporter 50 determines the fill level of the jitter buffer 32, such as by using hardware built into the router 16. The fill level of the jitter buffer 32 may vary over time as packets are received by the router 16 at varying intervals due to PDV yet packets are played out at regular intervals. At step 68 the teleprotection supporter 50 determines whether sufficient fill level measurements have been made, such as by using a counter. The number of fill level measurements is configured by the user, and can be expressed in any way such as number of measurements or total time. If not enough fill level measurements have been made, then the teleprotection supporter 50 waits the duration before monitoring the fill level again.

If on the other hand the teleprotection supporter 50 determines at step 68 that sufficient fill level measurements have been made, then at step 70 the teleprotection supporter 50 determines the average of the fill levels that were determined at step 66. At step 72 the teleprotection supporter 50 determines the difference between the average determined at step 70 and the expected fill level. The expected fill level is the fill level expected if the packets were to arrive at a constant rate, i.e. there was no PDV. At step 74 the teleprotection supporter 50 determines whether the absolute value of the difference determined at step 72 exceeds a predetermined configurable threshold. If the absolute value of the difference exceeds the threshold then the differential delay is too high, indicating that the jitter buffer latency is unacceptable. In such a case the TDM CES is deemed unacceptable and at step 60 the teleprotection supporter 50 instructs the CESoP processor 53 to restart the TDM CES. Restarting the TDM CES empties the jitter buffer 32, and the procedure is repeated.

If the teleprotection supporter 50 determines at step 74 that the absolute value of the difference does not exceed the threshold, then the jitter buffer latency is acceptable. The TDM CES is maintained and teleprotection services are continued as normal at step 76. When this is accomplished in both directions of the TDM CES, the latency introduced by the jitter buffers is under the tolerance level and the TDM CES is symmetrical in that respect.

The method has been described as comparing the absolute value of the difference between the average of the measured fill levels and the expected fill level with a threshold at step 74 in order to evaluate the jitter buffer latency. Alternatively the jitter buffer latency can be evaluated as being unacceptable if the actual value of the difference is larger than the threshold or if the actual value of the difference is less than zero, in which case the TDM CES is restarted.

In one embodiment, packets are transmitted to the TDM interworking function 34 even while determining the average of the fill levels. In another embodiment, teleprotection observations are not sent to the associated teleprotection device until an acceptable difference at step 74 is determined. For example, the router 16 can send all is to the teleprotection device until the difference is found to be acceptable, a sequence of all is being read by the teleprotection device as not representing real data. As another example, if an optical interface is used to communicate to the teleprotection device, the optical signal is only turned on when an acceptable jitter buffer latency is found to exist.

In one embodiment, the teleprotection supporter 50 is configurable to be either on or off. Such an embodiment is particularly useful if the operator of the teleprotection services is more concerned about delayed start of the teleprotection services than about initial accuracy.

The method is normally carried out only upon start of the teleprotection services. Alternatively, checks at configurable periods can be made as to whether the average jitter buffer fill level (indicating latency contribution) has become unacceptable. In such an embodiment, if the difference is found at step 74 to exceed the threshold and this is not the first check then restarting the TDM CES is only one possible action, any of which may be used alone or in combination. For example, an alarm could also be generated. As another example, additional bandwidth within the packet switched network can be purchased.

In the embodiment described above, the method repeats until the difference is found at step 74 to be acceptable. Alternatively a configurable maximum number of attempts can be made. If the configurable maximum number of attempts is made, then the teleprotection supporter 50 concludes that a TDM CES with an acceptable jitter buffer latency cannot be established. Any one of or a combination of actions may then be made, such as purchasing more bandwidth in the packet switched network 14 in an attempt to lower the jitter buffer latency, generating an alarm, or refraining from providing teleprotection services.

The teleprotection supporter described above is preferably implemented as logical instructions in the form of software. Alternatively, the teleprotection supporter may be implemented as hardware, or as a combination of software or hardware. If in the form of software, the logic of the teleprotection supporter may be stored on a non-transitory computer-readable storage medium in a form executable by a computer processor. The logic of the teleprotection supporter may be implemented by a general purpose processor, a network processor, a digital signal processor, an ASIC, or multiple such devices.

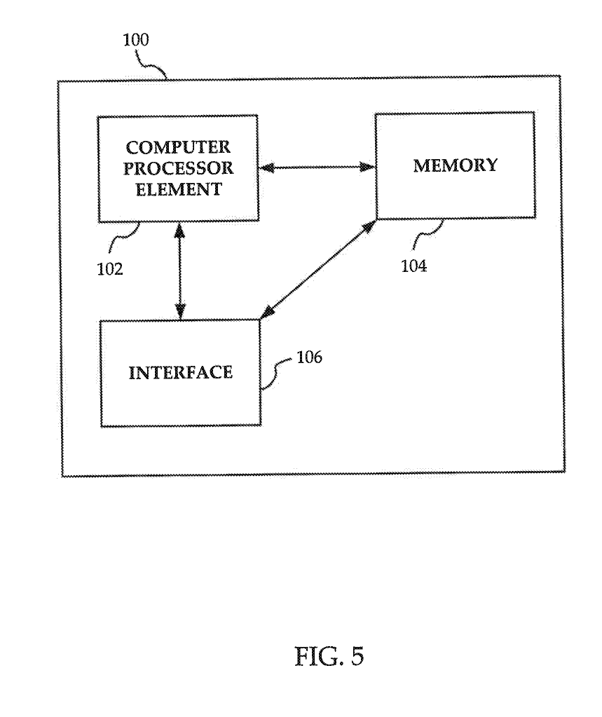

A simplified block diagram of one embodiment of the teleprotection supporter is shown in FIG. 5 as a processor assembly 100. The processor assembly 100 includes a computer processor element 102 (e.g. a central processing unit and/or other suitable processor(s)). The computer processor element 102 has access to a memory 104 (e.g. random access memory, read only memory, and the like). The processor element 102 and the memory 104 are also in communication with an interface comprising various I/O devices 106 (e.g. a user input device (such as a keyboard, a keypad, a mouse, and the like), a user output device (such as a display, a speaker, and the like), an input port, an output port, a receiver, a transmitter, and a storage device (such as a tape drive, a floppy drive, a hard disk, a compact disk drive, and the like)). In one embodiment, the teleprotection supporter is implemented as software instructions loaded into the memory 104 and causing the computer processor element 102 to execute the methods described above.

The embodiments presented are exemplary only and persons skilled in the art would appreciate that variations to the embodiments described above may be made without departing from the spirit of the invention. The scope of the invention is solely defined by the appended claims

I/we claim:

1. A method of providing teleprotection services over a packet switched network, the packet switched network including a first router providing Circuit Emulation Service (CES) and in TDM communication with a first teleprotection device and a second router providing CES and in TDM communication with a second teleprotection device, the first router and the second router being separated by the packet switched network, the method comprising:
establishing a TDM CES between the first teleprotection device and the second teleprotection device;
at the first router, receiving packets into a jitter buffer;
at regular periods, determining the fill level of the jitter buffer;
after a configured number of such determinations, determining an average of the determined fill levels;
comparing the average of the determined fill levels with an expected fill level in order to evaluate a jitter buffer latency; and
if the comparison indicates that the jitter buffer latency is unacceptable, then restarting the TDM CES.

2. The method of claim 1 wherein the comparison indicates that the jitter buffer latency is unacceptable if the absolute value of the difference between the average of the determined fill levels and the expected fill level exceeds a predetermined threshold.

3. The method of claim 1 wherein the comparison indicates that the jitter buffer latency is unacceptable if the difference between the average of the determined fill levels and the expected fill level exceeds a predetermined threshold or if the difference between the average of the determined fill levels and the expected fill level is below zero.

4. The method of claim 1 further comprising:
maintaining the TDM CES if the comparison indicates that the jitter buffer latency is acceptable; and
periodically:
determining the fill level of the jitter buffer at regular periods, determining an average of the determined fill levels after the configured number of such determinations, comparing the newly determined average with the expected fill level, and taking action if the comparison indicates that the jitter buffer latency is unacceptable.

5. The method of claim 4 wherein the action comprises at least one of purchasing additional bandwidth within the packet switched network and generating an alarm.

6. The method of claim 1 wherein the TDM CES is restarted a configurable number of times, after which at least one of generating an alarm and refraining from providing teleprotection services is carried out.

7. A router providing Circuit Emulation Services (CES) to a first teleprotection device, comprising:
a jitter buffer;
a CESoP processor for establishing a TDM CES between the first teleprotection device and a second teleprotection device, receiving packets received over a packet switched network and placing the packets in the jitter buffer, and playing out the packets into a TDM bitstream to the first teleprotection device; and
a teleprotection supporter for determining the fill level of the jitter buffer at regular periods, determining an average of the determined fill levels after a configured number of such determinations, comparing the average of the determined fill levels with an expected fill level in order to evaluate a jitter buffer latency, and instructing the CESoP processor to restart the TDM CES if the comparison indicates that the jitter buffer latency is unacceptable.

8. The router of claim 7 wherein the teleprotection supporter determines that the jitter buffer latency is unacceptable if the absolute value of the difference between the average of the determined fill levels and the expected fill level exceeds a predetermined threshold.

9. The router of claim 7 wherein the teleprotection supporter determines that the jitter buffer latency is unacceptable if the difference between the average of the determined fill levels and the expected fill level exceeds a predetermined threshold or if the difference between the average of the determined fill levels and the expected fill level is below zero.

10. The router of claim 7 wherein the teleprotection supporter periodically: determines the fill level of the jitter buffer at regular periods, determines an average of the determined fill levels after the configured number of such determinations, compares the newly determined average with the expected fill level, and takes action if the comparison indicates that the jitter buffer latency is unacceptable.

11. The router of claim 10 wherein the action comprises at least one of purchasing additional bandwidth within the packet switched network and generating an alarm.

12. The router of claim 7 wherein the teleprotection supporter instructs the CESoP processor a configurable number of times, after which the teleprotection supporter does at least one of generating an alarm and refraining from providing teleprotection services.
